(19) United States
(12) Patent Application Publication
(10) Pub. No.: US 2009/0223382 A1
(43) Pub. Date: Sep. 10, 2009

(54) TOASTER

(76) Inventor: Leslie Alexander Gort-Barten, Fulking (GB)

Correspondence Address: STITES & HARBISON, PLLC, 400 W MARKET ST, SUITE 1800, LOUISVILLE, KY, 40202-3352, US

(21) Appl. No.: 12/121,369

(22) Filed: May 15, 2008

(30) Foreign Application Priority Data
Mar. 4, 2008 (GB) 0804027.1
Mar. 26, 2008 (GB) 0805485.0

(51) Int. Cl. A47J 37/08

(52) U.S. Cl. 99/391

(57) ABSTRACT

A toaster has a carriage for raising and lowering a bread support in a pop-up toaster having a toasting cycle. The carriage is adapted to be guided on one or more vertical rods mounted on a housing of the toaster. The carriage includes a first member having an actuator, adapted to actuate a switch on the toaster to start the toasting cycle, the first member being further adapted to be held in a first position once the switch has been actuated. The carriage further includes a second member adapted to be independently moveable of the first member so that the bread support can be raised without actuating the switch or breaking contacts thereon. Once the toasting cycle is complete, the first member is released from a first position into a second position, in which second position the switch is not actuated and/or the contacts on the switch are broken.

The invention relates to a toaster and in particular to a carriage mechanism relating to the movement and control of the bread support of the toaster.

A traditional toaster comprises a housing, in which one or more bread supports are provided, which bread supports are adapted to support bread during a toasting operation, wherein heating elements are provided adjacent to the bread support to provide the heat for toasting the bread. The earliest commercial toasters used a simply lever mechanism to raise and lower the bread so that it was possible to see whether the bread had been sufficiently toasted.

Later toasters introduced some simple control features such as a timed pop up mechanism, in which after a pre-determined period of time the bread supported is lifted from the toasting position to a raised position using a spring mechanism. More recent innovation include additional settings such as a bagel setting, in which only one side of the bread is toasted or a defrost setting for making toast using frozen bread.

In most modern toasters, the heating elements and control circuitry are actuated by an actuator that is connected to the bread support, so that when the bread support is lowered, the actuator actuates a switch to turn on the heating elements and start the timer. When a predetermined time has elapsed, the timer switches off the heating elements and permits the bread support to pop-up.

This arrangement is resilient and simple and has established itself among manufacturers. However, it suffers from the drawback that it is not possible to raise the bread supports without breaking the contacts on the switch and turning off the heating elements. If the toast is not sufficiently browned, lowering the bread supports will simply start the process from the beginning again.

The invention therefore seeks to provide a mechanism which permits the bread supports to be raised without interrupting the toasting cycle.

According to the invention there is provided a carriage for raising and lowering a bread support in a pop-up toaster having a toasting cycle, which carriage is adapted to be guided on one or more vertical rods mounted on a housing of the toaster, the carriage comprising a first member having an actuator, adapted to actuate a switch on the toaster to start the toasting cycle, the first member being further adapted to be held in a first position once the switch has been actuated, and a second member adapted to be independently moveable of the first member so that the bread support can be raised without actuating the switch or breaking contacts thereon, wherein once the toasting cycle is complete, the first member is released from a first position into a second position, in which second position the switch is not actuated and/or the contacts on the switch are broken.

Preferably, spring means are provided which are adapted to raise the carriage from the first or second position to a raised position. Preferably, the carriage comprises a third member adapted to support the bread supports and to be raised by the second member. Preferably the carriage is adapted to be guided on two or more vertical rods mounted on the toaster housing. Preferably, forces on the carriage are reacted at at least three bearing points.

An exemplary embodiment of the invention will now be described in greater detail in which:

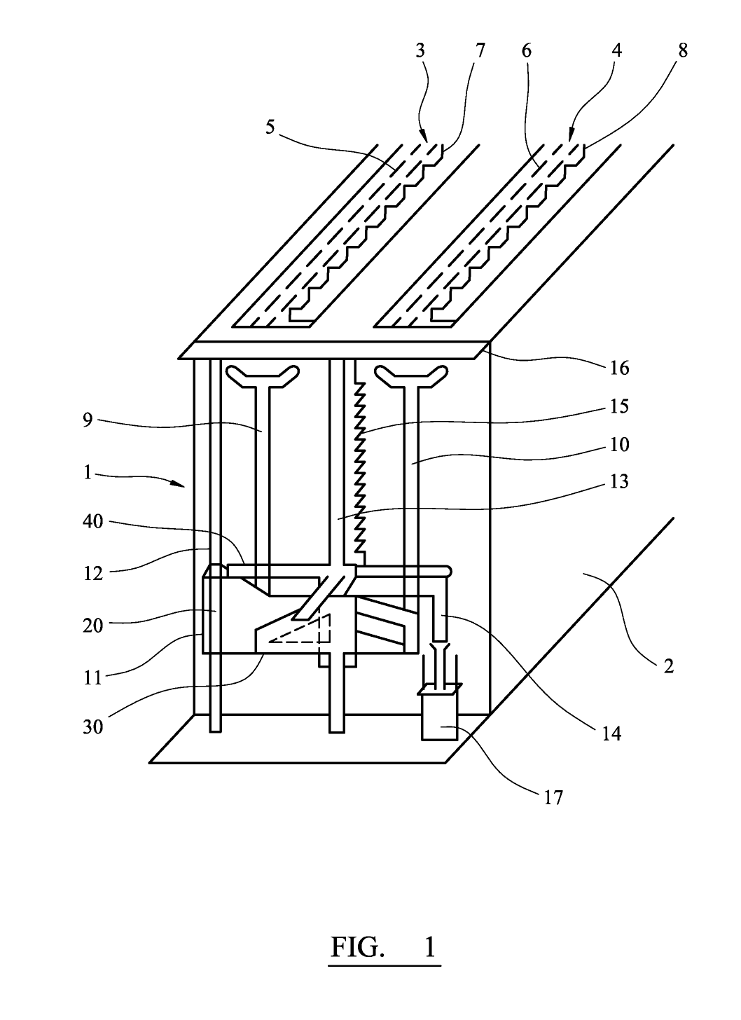

FIG. 1 shows a schematic plan view of a toaster

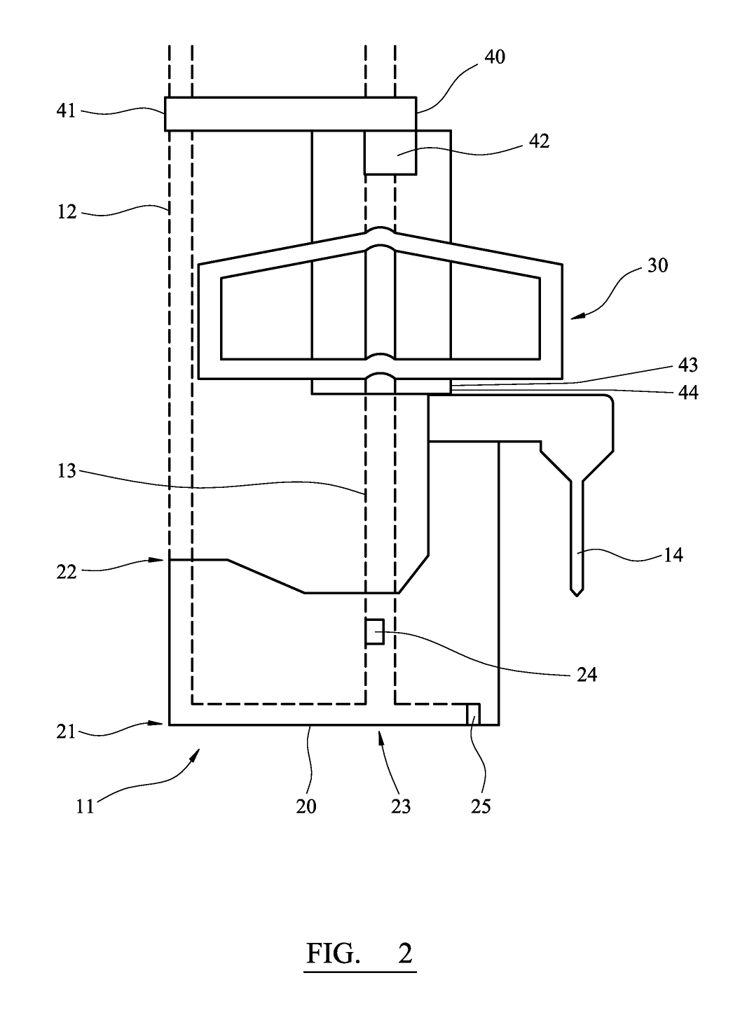

FIG. 2 shows an exploded view of a carriage for the bread support

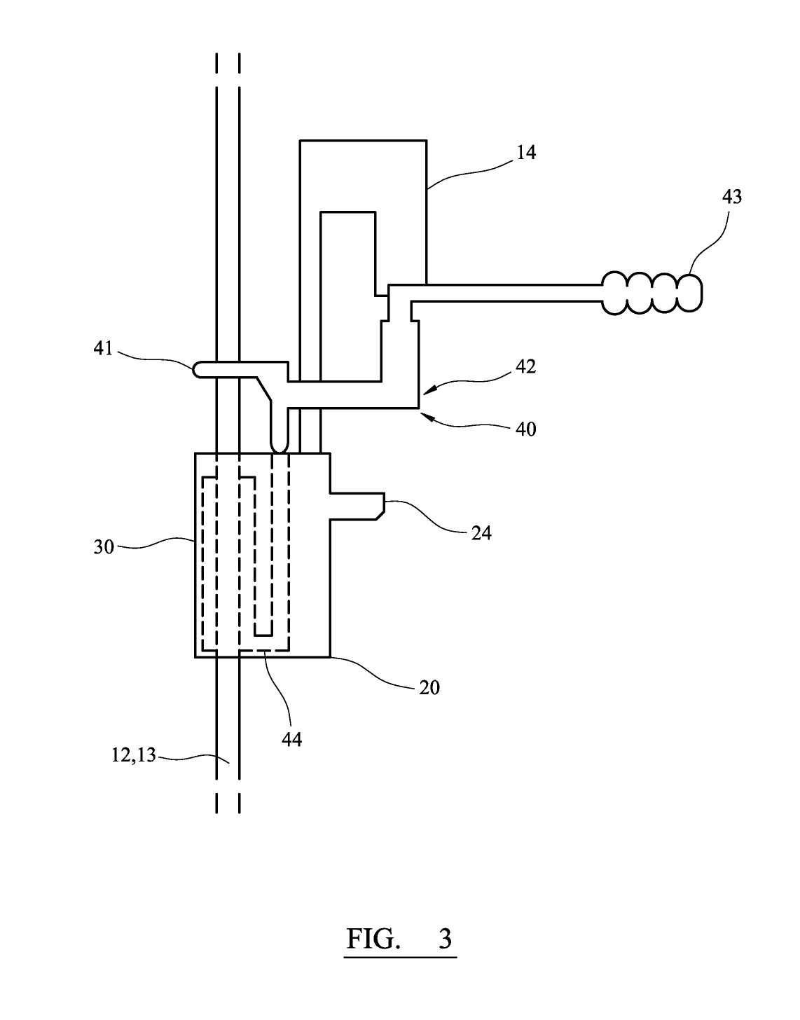

FIG. 3 shows a side view of the carriage

FIG. 1 shows a schematic plan view of a toaster 1 comprising a main housing 2 having first and second bread cavities 3,4. Heating elements 5,6 are arranged in each bread cavity 3,4 and in use are adapted to toast a piece of bread located on a respective bread support 7,8. Each bread support 7,8 comprises a plurality of alternating metal supports and extends through a respective slot 9,10. The bread supports are also supported at the end of the bread cavities 3,4.

The two bread supports 7,8 are attached to a carriage 11, which is adapted to slide on two vertical rods 12,13, the lower ends of which are mounted on the base of the housing 2 and the upper ends of which are attached to a flange 16 extending from the upper surface of the toaster. The rod 13 is located substantially equidistantly from the two bread cavities 3,4. A spring 15 is attached to both the flange 16 and the carriage 11, so that the carriage is urged into a raised position in which the bread or toast is raised above the upper surface of the housing.

The switch 17 for actuating the timer, pop-up and heating elements comprises two pairs of upstanding elements having opposing contacts at their distal ends. The downward projection 14 which is integral with the carriage 11, in use, will force the respective contacts together when it is inserted between the two pairs of upstanding contact arms. As the upstanding contact arms are resilient, the downward projection is urged away from the lowest position by the resilience of the contact arms. The carriage 11 is held in the lower position against the force generated by the spring by means of an electromagnet, which is actuated by the closing of the contacts. Once the predetermined toasting time has elapsed, the timer circuit breaks the contact so that the carriage is released from the lowest position. The carriage 11 comprises three parts: the first part comprises a moulding 20 including the switch actuator 14, the second part comprises a member 30 adapted to support the bread supports and the third part 40 comprises a further member adapted to enable the member 30 to be raised independently of the moulding 20. The construction of the three parts will now be described in greater detail with reference to FIGS. 2 and 3.

FIG. 2 shows an exploded front view of the carriage 11, with the position of the vertical metal rods 12,13 being shown in dotted lines. The carriage 11 comprises three parts.

The lower part 20 of the carriage 11 comprises a single piece moulding, which has two bearing surfaces 21 and 22 for the rod 12 located at its lower and upper edges. The rod 13 bears against the lower surface 23 of the lower part 20. The lower part 20 is further provided with an upstanding member from which the projection 14 depends, spatially separated from the rod 13, so that the projection 14 can engage the upstanding contact arms in the lowered position in use. Projecting from the face of the lower part 20 is an engagement member 24, adapted to engage with a corresponding member adapted to be held in position by the electromagnet actuated by the insertion of the member 14 into the upstanding contact arms. The engagement member thus holds the lower part in position during toasting. The lower member is provided with a hole 25 which is adapted to receive the end of the spring 15 in the installed position.

The centre member 30 is mounted in use on the road 13 and is provided with two symmetrical winged portions adapted to receive and support the ends of the bread supports 7,8, which in the installed position can then move up and down in the slots 9,10.

The upper member 40 comprises an upper horizontal element 41 adapted to bear and run on the rods 12, 13 and protruding from the front of the horizontal element in front of the rod 13 is a support 42 for a handle 43. The upper member 40 further comprises a vertical element extending substantially down the rod 13 and bearing at its lower end on the rod 13. The lower edge of the vertical element is provided with a flange 44, which is adapted to support the centre member 30. A small amount of play is provided between the upper member 40 and the centre member 30. This play permits the upper member 40 to be used to apply downward force to the centre and lower members 20,30 so that the lower member can be pushed down against the spring pressure to actuate the switch and the electromagnet to thereby be held in position. In this lowest position, there is some space between the lower edge of the centre member 30 and the flange 44 which rests on the lower member 20.

One advantage of using two rods is that it is possible to react the forces acting on the lower and upper members over three points, which will lead to a smoother, more stable action and a greater life for the product.

FIG. 3 shows the carriage in assembled form showing the lower member 20 and the upper member 40. The centre member 30 is shown in dotted lines about the rod 12,13. The protruding members 42 with handle 43 and 24 both extend away from the housing 2.

In use, a user will load one or both bread supports 7,8 with bread to be toasted and lower the supports against the bias of the spring 15 using the handle 43 until the member 14 engages with the upstanding contact arms and closes the contacts thereon, actuating the switch in the circuit. The electromagnet is also actuated and engages with the protrusion 24 so that the carriage 11 is held in the lowest position against the bias of both the spring 15 and the resilience of the upstanding contact arms.

In this lowest position, it is possible to use the handle 43 to lift the bread supports 7,8 via the centre and upper members from the lowest position so that the degree of toasting can be inspected and then to lower the supports back down to the lowest position so that the toasting continues on the same cycle without the cycle having been interrupted as the switch is still in the actuated position as the lower member 20 is not moved during this operation.

If an item becomes stuck in the toasting position, once the predetermined time has elapsed, the electromagnet is released and the element 14 is released from its lowest position by the resilience of the upstanding contact arms, so that the contacts on the end of the upstanding contact arms are broken. In this manner, even if the bread supports jam in their lowest position, the circuit is broken and the toast can be removed by using the lever to raise the bread supports and there is little risk of the bread catching fire due to excessive toasting. In this situation, the lower member 20 is lifted upwards by the spring pressure of both the spring 13 and the resilience of the upstanding contact arms. The lower member 20 and the upper member 40 are therefore raised until the flange 44 abuts the lower surface of the centre member 30, which will still be in its lowest position with the bread supports at their lowest point in the slots 9,10. In this manner, if an item is jammed in the toaster in the toasting position with the bread supports at their lowest extent, the contacts of the switch have been broken and the toaster switched off so that the risk of the toasted item catching fire is greatly reduced. The bread supports can then be manually lifted as the flange 44 supports the centre member and hence the bread supports and the flange 44 and upper member can be moved independently thereby enabling the bread supports to be manually raised to remove any blockage.

However, in normal use once power is cut to the electromagnet, the spring 15 will lift the toasted bread to a raised position, from where it can be removed. The carriage mechanism of the invention therefore enables inspection of the toast during the toasting cycle on a pop up toaster.

Although the electrical circuit has been described in a simple manner, further electronic controls could easily be included such as bagel settings and defrost. Although the carriage has been described as having three parts, it would be possible to combine the upper and centre members into a single member.

1. A toaster having a carriage for raising and lowering a bread support in a pop-up toaster having a toasting cycle, which carriage is adapted to be guided on one or more vertical rods mounted on a housing of the toaster, the carriage comprising a first member having an actuator, adapted to actuate a switch on the toaster to start the toasting cycle, the first member being further adapted to be held in a first position once the switch has been actuated, the carriage further comprising a second member adapted to be independently moveable of the first member so that the bread support can be raised without actuating the switch or breaking contacts thereon, wherein once the toasting cycle is complete, the first member is released from a first position into a second position, in which second position the switch is not actuated and/or the contacts on the switch are broken.

2. The toaster according to claim 1, wherein spring means are provided which are adapted to raise the carriage from the first or second position to a raised position.

3. The toaster according to claim 1, wherein the carriage comprises a second member comprises a member adapted to support the bread support and a third member adapted to raised by the second member supporting the bread support.

4. The toaster according to claim 1, wherein the carriage is adapted to be guided on two or more vertical rods mounted on the toaster housing.

5. The toaster according to claim 1, wherein the toaster comprises at least two vertical rods and forces on the carriage are reacted at least three bearing points on the vertical rods.

6. The toaster according to claim 1, wherein the lowest position of the second member is higher than the lowest position of the first member.

7. The toaster according to claim 3, wherein play is provided between the member adapted to support the bread support and a third member, the third member being provided with a flange adapted to provide support to said member, wherein in the first position, there is space between the flange and a lower surface of the said member.

8. The toaster according to claim 7, wherein in the second position, the flange abuts the said member

9. (canceled)
